(19) United States
(12) Patent Application Publication
(10) Pub. No.: US 2026/0147164 A1
(43) Pub. Date: May 28, 2026

(54) CONNECTOR INSTALLATION AND REMOVAL TOOLS AND METHODS FOR OPTICAL CONNECTORS

(71) Applicant: Sumitomo Electric Lightwave Corp., Raleigh, NC (US)

(72) Inventor: Guilherme Doro Roncoleta, Irvine, CA (US)

(21) Appl. No.: 18/961,815

(22) Filed: Nov. 27, 2024

(51) Int. Cl. G02B 6/38

(52) U.S. Cl. CPC G02B 6/3898

(57) ABSTRACT

A tool for installing and removing a fiber optic connector and a dust cap in/from a port. The tool has first and second arms that are pivotably attached to each other. The first and second arms each have, on a first side of the pivot point, a grasping portion and, on a second side of the pivot point, a grip portion. The grasping portions of the first and second arms can selectively grasp and manipulate either of the fiber optic connector and the dust connector.

### BACKGROUND

The rapid growth of e-commerce, video streaming services, and cloud computing services requires a commensurate rapid growth in computing infrastructure, including locations commonly referred to as “datacenters.” In order for a datacenter to be operational, however, not only must each of the computer servers be installed within racks in the datacenter and provided with power, but these computer servers must be interconnected together and/or with communications equipment (e.g., switches) that is also provided within such datacenters, such that data can be transferred to/from/between each of these computer servers for performing a designated function.

Due to the proliferation of high-speed internet connections for users, the need for increased data transmission bandwidth continues to increase. One of the most efficient data transfer cable mediums is fiber optic cable, through which a signal can travel at speeds approaching the speed of light. However, such fiber optic cables must first be “terminated,” meaning to have a connector rigidly attached to the end of the fiber optic cable. These connectors allow for a rigid connection between the fiber optic cable and the computer infrastructure device (e.g., computer or switch) that ensures uninterrupted receipt/transmission of data through the fiber optic cable, while also protecting the fiber optic cable from being damaged.

When building a datacenter, data transmission cables, such as fiber optic cables, must be connected between computer servers and/or switches. However, the act of “terminating” a fiber optic cable is very time and labor intensive. Thus, the use of pre-terminated cables can be used to significantly reduce the amount of time required to bring new datacenters online, since the cable termination step can be omitted. It is often necessary for fiber optic cables to be connected to an adapter mounted within a panel. Indeed, it is often necessary for connectors for such fiber optic cables to be removed and replaced with a dust cap when a fiber optic cable needs to be removed and replaced. However, the handling of such pre-terminated cables by datacenter installation personnel and the connection of such pre-terminated cables to an adapter is cumbersome at present, especially in light of the small dimensions of the connectors and dust caps and also the small spacing between adjacent ports in such adapters.

High-density optical panels are characterized by closely packed connections, where even minor physical disturbances can disrupt active network components, leading to signal degradation or complete disconnection. Traditional tools, or even manual handling, often result in unintentional disturbances that compromise network performance. These issues are particularly problematic in mission-critical applications where uptime and reliability are paramount.

Current tools available on the market are generally designed for broad use without specific consideration for the constraints of high-density environments. Many of these tools lack the precision and flexibility needed to navigate the tight spaces between connectors without making unintended contact with adjacent components. Furthermore, the rigidity of these tools can result in excessive force being applied to the connectors or dust caps, increasing the risk of damage.

Thus, a need exists for a device suitable for use with such cable connectors that simplifies the installation and removal of the connectors of such pre-terminated cables, as well as dust caps, in the adapters.

### SUMMARY

High-density optical panels are characterized by closely packed connections, where even minor physical disturbances can disrupt active network components, leading to signal degradation or complete disconnection. Traditional tools, or even manual handling, often result in unintentional disturbances that compromise network performance. These issues are particularly problematic in mission-critical applications where uptime and reliability are paramount.

Current tools available on the market are generally designed for broad use without specific consideration for the constraints of high-density environments. Many of these tools lack the precision and flexibility needed to navigate the tight spaces between connectors without making unintended contact with adjacent components. Furthermore, the rigidity of these tools can result in excessive force being applied to the connectors or dust caps, increasing the risk of damage.

Given these challenges, there is a clear need for a specialized tool that can facilitate the safe and efficient removal of optical connectors and dust caps in densely populated panels. The ideal tool must ensure precision handling, minimize the risk of disrupting adjacent connections, and be versatile enough to accommodate connectors and dust caps, reducing the need for multiple tools.

The tool disclosed herein is designed to address these specific needs, offering several key innovations that distinguish it from existing solutions. The multi-functional head is designed to work with optical connectors and dust caps ensuring a secure grip on connectors and dust caps while minimizing the application of excessive force. Additionally, the tool's minimal-contact design reduces the likelihood of accidental disruptions to adjacent connections, making it particularly suitable for high-density environments.

### BRIEF DESCRIPTION OF THE DRAWINGS

One or more example embodiments of the disclosed device are described herein, with reference to the accompanying drawings, in which:

FIG. 1 is a perspective view showing features of an example embodiment of a tool for use in installing and removing fiber optic cable connectors and dust caps.

FIG. 2 is another perspective view of the tool shown in FIG. 1.

FIG. 3 is a side perspective view of the tool shown in FIGS. 1 and 2 in a first orientation, the tool being engaged with a dust cap.

FIG. 4 is a side perspective internal view of the tool engaged with the dust cap, as shown in FIG. 3.

FIG. 5 is a side perspective view of the tool shown in FIGS. 1 and 2 in a second orientation that is rotated 180° from the first orientation, the tool being engaged with a dust cap.

FIG. 6 is a side perspective internal view of the tool engaged with the dust cap, as shown in FIG. 5.

FIG. 7 is a side perspective view of the tool shown in FIGS. 1 and 2 in a first orientation, the tool being engaged with a fiber optic cable connector.

FIG. 8 is a side perspective internal view of the tool engaged with the fiber optic cable connector, as shown in FIG. 7.

FIG. 9 is a side perspective view of the tool shown in FIGS. 1 and 2 in a second orientation that is rotated 180° from the first orientation, the tool being engaged with a fiber optic cable connector.

FIG. 10 is a side perspective internal view of the tool engaged with the fiber optic cable connector, as shown in FIG. 9.

FIG. 11 is a perspective view of a first arm of the tool shown in FIGS. 1 and 2.

FIG. 12 is a partial internal view of the tool shown in FIGS. 1 and 2, with the feature of the central limiter shown clearly therein.

FIGS. 13 and 14 are respective perspective views of the tool shown in FIGS. 1 and 2 being used in the first orientation to select and engage with a fiber optic cable connector installed in one of the ports of a multi-port adapter housing.

FIGS. 15 and 16 are respective perspective views of the tool shown in FIGS. 1 and 2 being used in the second orientation to select and engage with a fiber optic cable connector installed in one of the ports of a multi-port adapter housing.

FIGS. 17 and 18 are respective perspective views of the tool shown in FIGS. 1 and 2 being used in the first orientation to select and engage with a dust cap installed in one of the ports of a multi-port adapter housing.

FIGS. 19 and 20 are respective perspective views of the tool shown in FIGS. 1 and 2 being used in the second orientation to select and engage with a dust cap installed in one of the ports of a multi-port adapter housing.

The drawings are not necessarily to scale. The drawings are merely representations, not intended to portray specific parameters of the disclosure. The drawings are intended to depict example embodiments of the disclosure, and therefore are not to be considered as limiting in scope. In the drawings, like numbering represents like elements.

### DETAILED DESCRIPTION

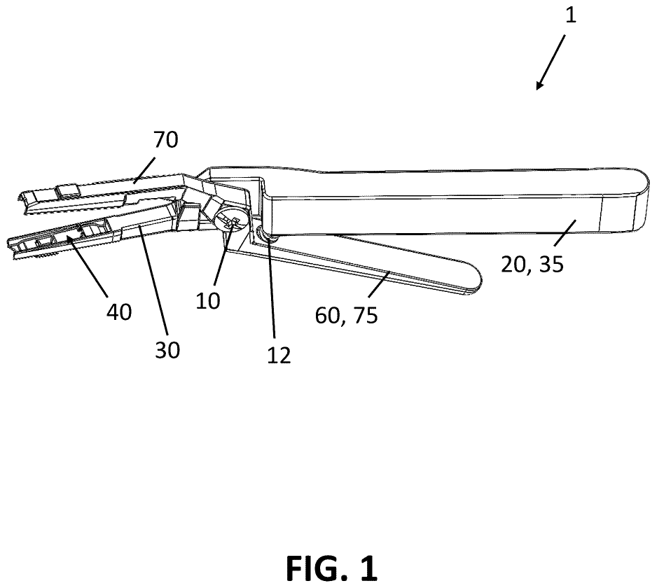

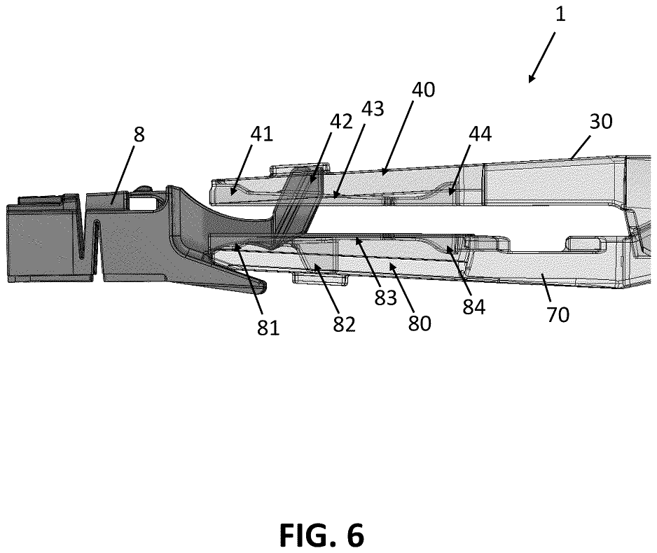

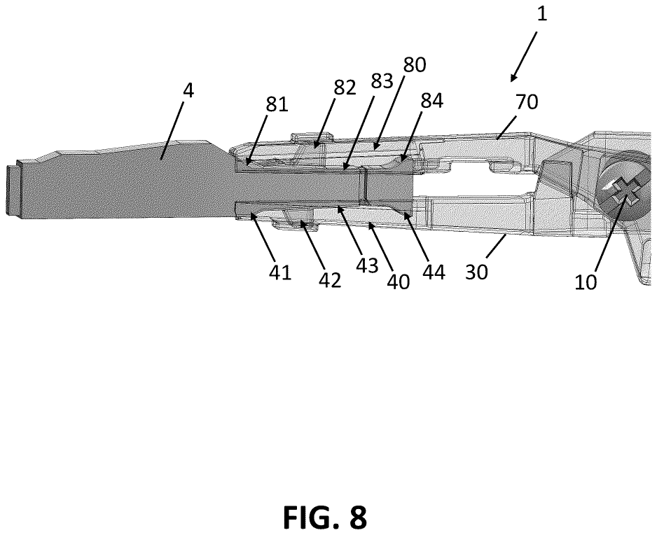

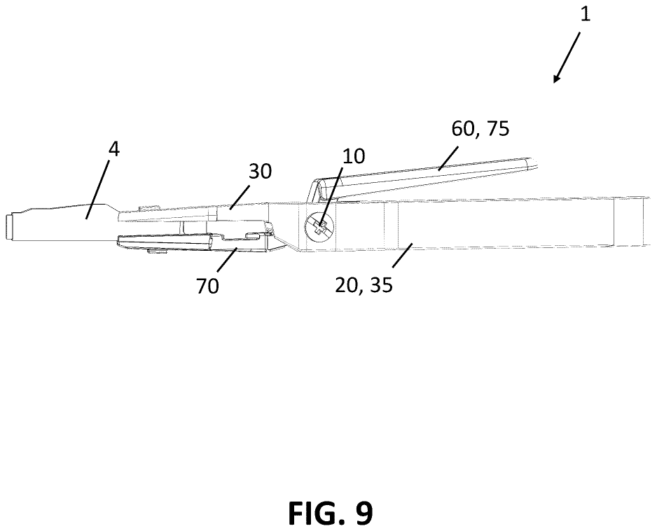

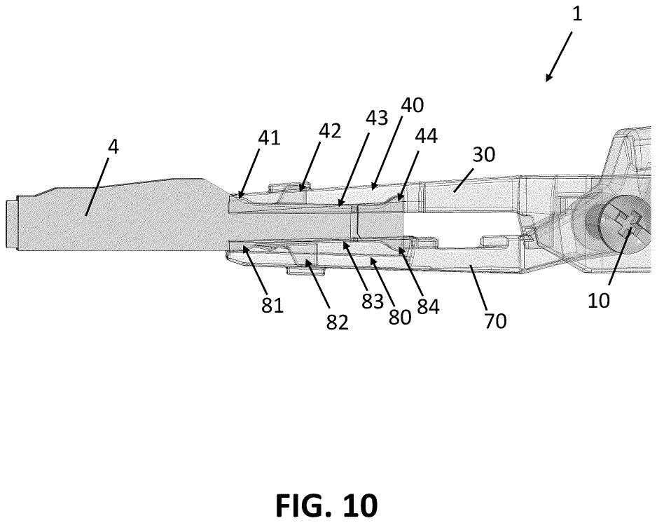

Features of an example embodiment of a tool, generally designated 1, are shown in FIGS. 1-20. The tool 1 is configured to allow for installation and removal of a compatible connector (e.g., of a fiber optic cable) and of a compatible dust cap (e.g., shaped to fit within a port from which such fiber optic cable connector has been removed). One non-limiting example of such a compatible dust cap is disclosed in U.S. patent application Ser. No. 18/905,396, filed on Oct. 3, 2024, the entire contents of which is incorporated herein. The tool 1 is formed by a first arm 20 and a second arm 60, which are pivotable relative to each other about a pivot point 10. In the example embodiment shown, the first and second arms 20, 60 are pivotably attached to each other by a rigid fastener (e.g., a screw, rivet, etc.)

The first arm 20 has a grasping portion 30 and a grip portion 35 that extend away from each other, respectively, on opposing sides of the pivot point 10. The second arm 60 has a grasping portion 70 and a grip portion 75 that extend away from each other, respectively, on opposing sides of the pivot point 10. The grip portions 35, 75 are arranged and shaped to be gripped manually by a user's hand and pivoted towards and away from each other depending on whether the grasping portions 30, 70 are engaging with or releasing a connector or dust cap.

The first arm 20 is advantageously formed as a single piece, having a unitary, monolithic structure. Thus, as defined herein, the grasping portion 30 and the grip portion 35 are not assembled together to form a first arm 20 made out of multiple pieces but are instead formed as a continuous, indivisible structure. The second arm 60 is advantageously formed as a single piece, having a unitary, monolithic structure. Thus, as defined herein, the grasping portion 70 and the grip portion 75 are not assembled together to form a second arm 60 made out of multiple pieces but are instead formed as a continuous, indivisible structure.

The first arm 20 advantageously has a bent, or nonlinear shape, such that the longitudinal axis of the grasping portion 30 and the longitudinal axis of the grip portion 35 are neither parallel to each other nor coaxial with each other but are instead inclined at a nonzero angle relative to each other. The second arm 60 advantageously has a bent, or nonlinear shape, such that the longitudinal axis of the grasping portion 70 and the longitudinal axis of the grip portion 75 are neither parallel to each other nor coaxial with each other but are instead inclined at a nonzero angle relative to each other. The grasping portions 30, 70 of the first and second arms 20, 60 are advantageously arranged such that the respective longitudinal axes thereof are parallel to each other and define a plane in which the grasping portions 30, 70 pivot towards and away from each other during use. The grip portions 35, 75 of the first and second arms 20, 60 are advantageously arranged such that the respective longitudinal axes thereof are parallel to each other and define a plane in which the grip portions 35, 75 pivot towards and away from each other during use. The plane defined by the grasping portions 30, 70 and the plane defined by the grip portions 35, 75 are inclined at a nonzero angle relative to each other, these planes intersecting each other at the pivot point 10.

The grasping portions 30, 70 have respective grasping profiles 40, 80 that are formed in (e.g., a s depressed areas of) the respective opposing surfaces of the grasping portions 30, 70, such that the grasping profiles 40, 80 form opposing cavities that are shaped to conform against and grasp onto opposing upper and lower surfaces of a fiber optic cable connector and also a dust cap that is shaped to fit within a fiber optic cable connector port.

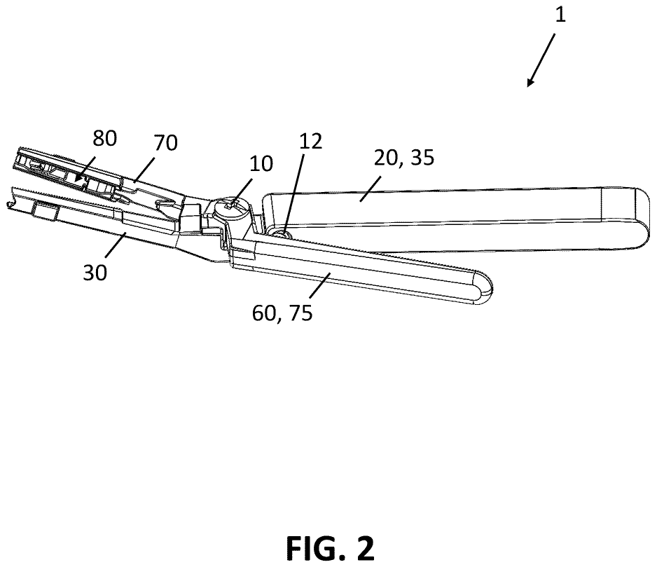

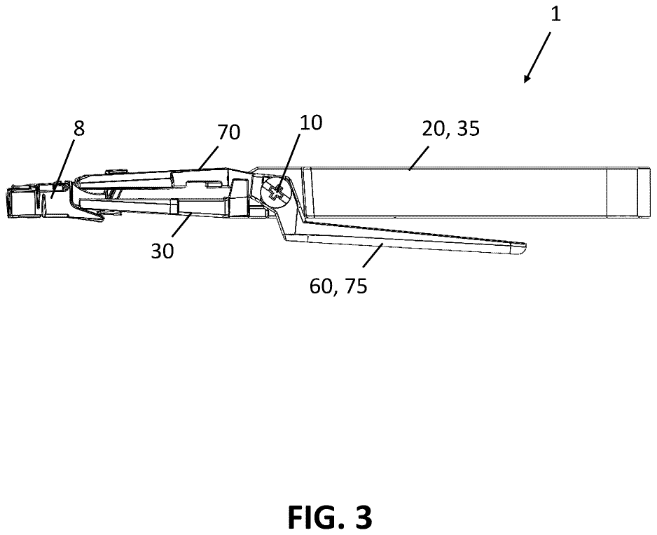

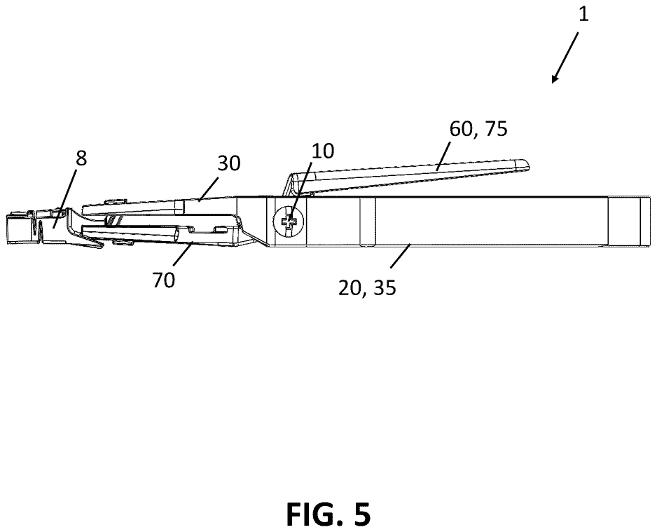

The first and second arms 20, 60 are pivotable between an open position, shown in FIGS. 1 and 2, and a closed position, shown in FIGS. 3 and 5, for example. An elastic element (e.g., spring 12) is provided to bias the first and second arms 20, 60 into the open position. The spring 12 is positioned and held captive between the respective grip portions 35, 75 of the first and second arms 20, 60. The spring 12 can be any suitable type of spring or elastic element but, in the example embodiment shown, the spring 12 is a coil spring. When a user applies a compressive force to cause the first and second arms 20, 60 pivot from the open position into the closed position, the respective grip portions 35, 75 pivot towards each other to compress the spring 12. When this compressive force is released by the user, the mechanical energy stored in the spring 12 is released, thus causing the grip portions 35, 75 to pivot away from each other, towards and into the closed position. The opposing facing surfaces of the grip portions 35, 75 can have a recess or other retention feature that holds the spring 12 in place and prevents the spring 12 from being unintentionally separated from the tool 1.

The first and second arms 20, 60 may be formed such that, even when in the closed position, the respective longitudinal axes of the grip portions 35, 75 are not parallel to each other, as shown, for example, in at least FIGS. 3 and 5.

The tool 1 disclosed herein is advantageously capable of being used to engage with a connector 4 or a dust cap 8 in a first orientation (see, e.g., FIGS. 3, 4, 7, and 8, in which the grasping portion 30 of the first arm 20 is positioned to engage with a bottom surface of the connector 4 or dust cap 8 and the grasping portion 70 of the second arm 60 is positioned to engage with a top surface of the connector 4 or dust cap 8) or in a second orientation (see, e.g., FIGS. 5, 6, 9, and 10, in which the grasping portion 30 of the first arm 20 is positioned to engage with a top surface of the connector 4 or dust cap 8 and the grasping portion 70 of the second arm 60 is positioned to engage with a bottom surface of the connector 4 or dust cap 8). The tool 1 is rotated by about 180° (e.g., about a longitudinal axis of the connector 4 or of the dust cap 8) between the first and second orientations shown in the various figures of the instant application.

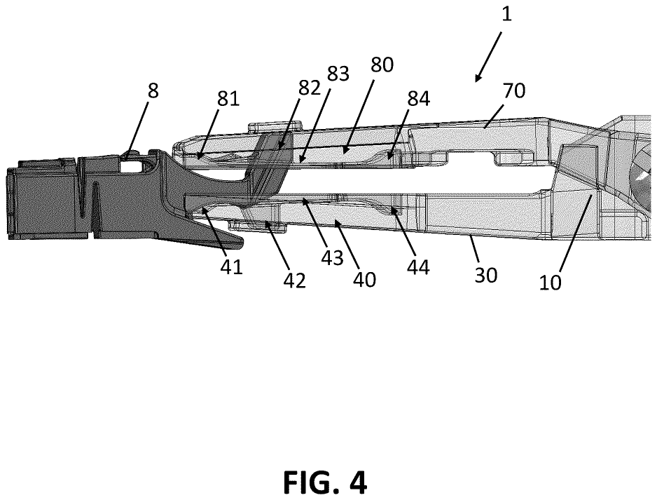

Features of the grasping profiles 40, 80 of the grasping portions 30, 70 of the first and second arms 20, 60 are shown most clearly in FIGS. 4, 6, 8, and 10. The grasping profiles 40, 80 have different features that engage with different portions of the connector 4 or dust cap 8, as the case may be.

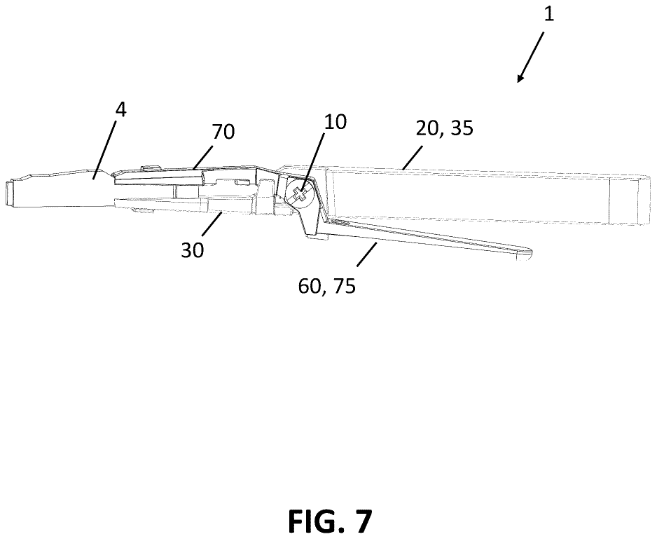

While the grasping profiles 40, 80 may be formed over the entire surface of the grasping portions 30, 70, in the example embodiment shown herein, the grasping profiles 40, 80 are formed over less than all (e.g., about 60-70%) of the length of the grasping portions 30, 70; the grasping profiles 40, 80 are formed at a distal end of the respective grasping portions 30, 70, these respective distal ends being the ends of the grasping portions 30, 70 that are furthest away from the pivot point 10. The grasping profiles 40, 80 can have any suitable shape for grasping onto and holding two differently-shaped structures, such as the connector 4 (see FIGS. 7-10) and the dust cap 8 (see FIGS. 3-6).

The grasping profile 40 comprises at least 4 separate segments or section. Starting from the distal end, a first channel segment 41 is formed, extending in the direction of the pivot point 10. The first channel segment 41 is formed as a substantially negative volume of a first portion of the connector 4 against which the first channel segment 41 is configured to engage. Next, in communication with and formed continuously with the first channel segment 41, the grasping profile 40 comprises a first recess 42. The first recess 42 is shaped to receive a grasping portion of the dust cap 8 therein. During engagement with the connector 4, substantially no portion of the connector 4 extends into the first recess 42. Next, in communication with and formed continuously with the first recess 42, the grasping profile 40 comprises a second channel segment 43. The second channel segment 43 is formed as a substantially negative volume of a second portion of the connector 4 against which the second channel segment 43 is configured to engage. Next, in communication with and formed continuously with the second channel segment 43, the grasping profile 40 comprises a second recess 44. The second recess 44 is formed as a substantially negative volume of a third portion of the connector 4 against which the second recess 44 is configured to engage. When the tool 1 is engaging with the dust cap 8, no portion of the dust cap 8 is engaged within the second channel segment 43 or the second recess 44.

The grasping profile 80 comprises at least 4 separate segments or section. Starting from the distal end, a first channel segment 81 is formed, extending in the direction of the pivot point 10. The first channel segment 81 is formed as a substantially negative volume of a first portion of the connector 4 against which the first channel segment 81 is configured to engage. Next, in communication with and formed continuously with the first channel segment 81, the grasping profile 80 comprises a first recess 82. The first recess 82 is shaped to receive a grasping portion of the dust cap 8 therein. During engagement with the connector 4, substantially no portion of the connector 4 extends into the first recess 82. Next, in communication with and formed continuously with the first recess 82, the grasping profile 70 comprises a second channel segment 83. The second channel segment 83 is formed as a substantially negative volume of a second portion of the connector 4 against which the second channel segment 83 is configured to engage. Next, in communication with and formed continuously with the second channel segment 83, the grasping profile 80 comprises a second recess 84. The second recess 84 is formed as a substantially negative volume of a third portion of the connector 4 against which the second recess 84 is configured to engage. When the tool 1 is engaging with the dust cap 8, no portion of the dust cap 8 is engaged within the second channel segment 83 or the second recess 84.

The grasping profiles 40, 80 are advantageously nonsymmetrically shaped with respect to each other. Thus, at least the first recesses 42, 82 are spaced apart from the distal end of the first and second arms 20, 60 by a different distance from each other. The distal end of the first arm 20 is coplanar with the distal end of the second arm 60. Stated somewhat differently, the first channel segment 41 has a different length than the first channel segment 81.

The first channel segment 41, the first recess 42, the second channel segment 43, and the second recess 44 are formed as a single, continuous, uninterrupted volumetric region.

The first channel segment 81, the first recess 82, the second channel segment 83, and the second recess 84 are formed as a single, continuous, uninterrupted volumetric region.

The first channel segment 41, the second channel segment 43, and the second recess 44 are formed negative, or hollow, region having the same shape as the portion of the outer surface of the connector 4 with which the grasping profile 40 is designated to engage during an insertion or removal procedure of such connector 4.

The first channel segment 81, the second channel segment 83, and the second recess 84 are formed negative, or hollow, region having the same shape as the portion of the outer surface of the connector 4 with which the grasping profile 80 is designated to engage during an insertion or removal procedure of such connector 4.

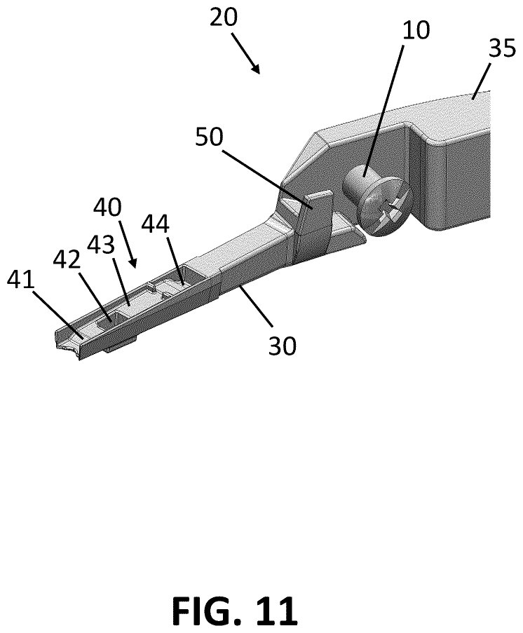

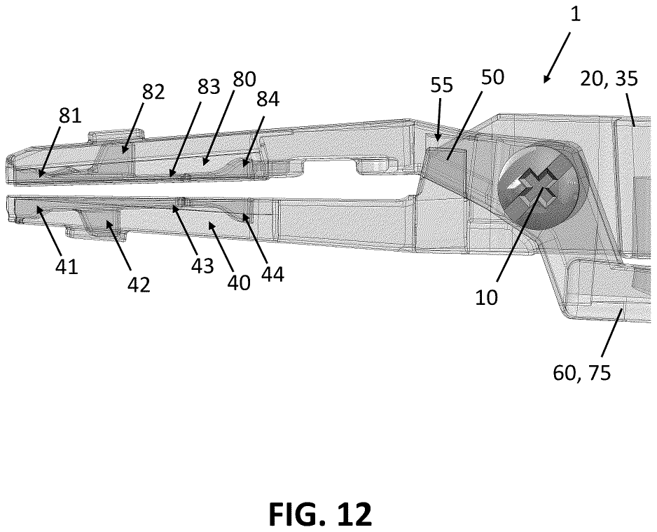

FIGS. 11 and 12 show features related to a central limiter 50 that can be provided on either the first arm 20 or the second arm 60. In the example embodiment shown, however, the central limiter 50 is formed on the first arm 20. The central limiter 50 is aligned with a recess 55 that is formed within the second arm 60. In embodiments in which the central limiter 50 is formed as part of the second arm 60, the recess 55 is necessarily formed within the first arm 20.

The central limiter 50 and the recess 55 are, regardless in which of the first and second arms 20, 60 such features are formed, aligned with each other. For example, this alignment of the central limiter 50 and the recess 55 can cause the central limiter and the recess 55 to move, when the grasping portions 30, 35 move relative to each other by pivoting around the pivot point 10, in the same plane as each other. Thus, the central limiter 50 and the recess 55 are arranged coplanar with each other. This plane in which the central limiter 50 and the recess 55 are arranged coplanar with each other is coplanar with or parallel to the plane in which the grasping portions 30, 35 are located and pivot relative to each other when moving between and including the respective open and closed positions.

The recess 55 is formed such that a depth thereof (e.g., measured in the direction of rotation of the first and second arms 20, 60 towards the closed position) and the height of the central limiter 50 (e.g., measured in the same direction as the recess 55) define the closed position since, when the central limiter 50 contacts the inner surface of the recess 55, further movement of the central limiter 50 into the recess 55 and, thus, further pivoting movement of the first and second arms 20, 60 towards each other, is prevented. Thus, by selecting the height of the central limiter 50 and/or the depth of the recess 55, the positions of the first and second arms 20, 60 relative to each other in the closed position can be controlled. The central limiter 50 and the recess 55 engage with each other in the manner of a physical stop.

By using the central limiter 50 and recess 55 to define the closed position of the first and second arms 20, 60, excess clamping or grasping force from the grasping portions 30, 35 can be prevented from being transmitted to the grasped surfaces of the connector 4 and/or the dust cap 8, as the case may be, thereby preventing damage to such connector 4 or dust cap 8 from a user exerting excess force on such grasped surfaces using the tool 1.

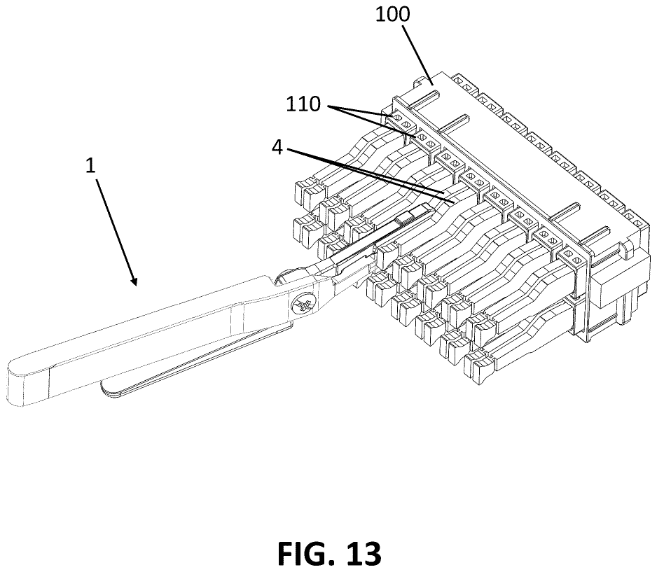

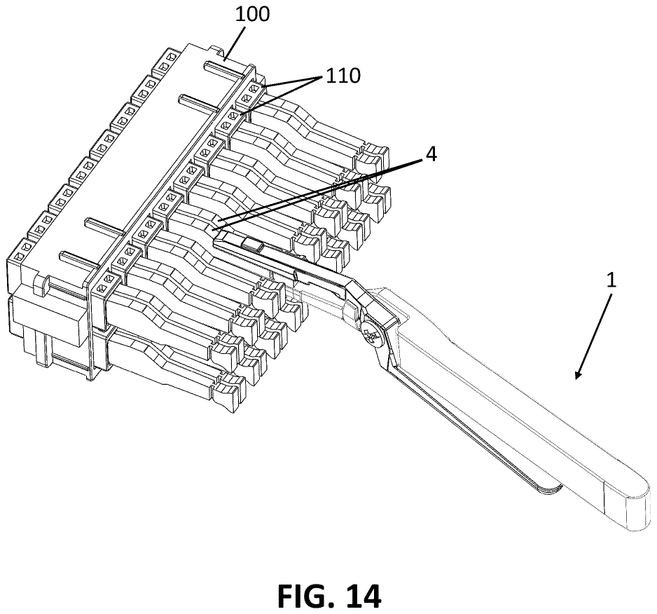

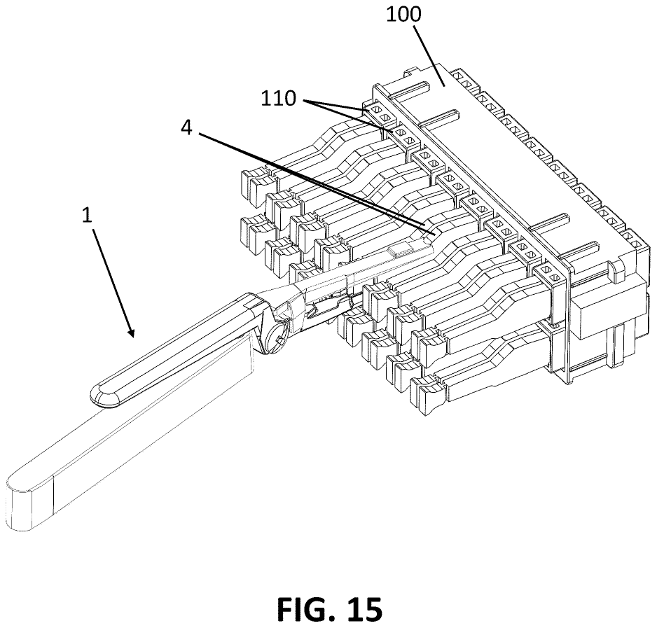

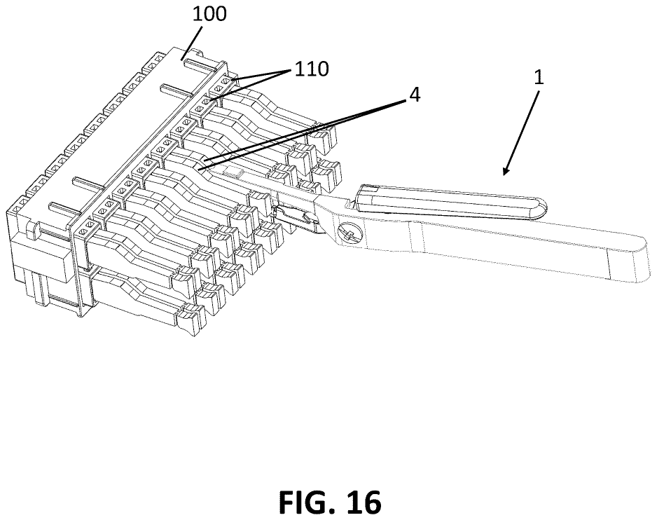

FIGS. 13-20 show the tool 1 being used for engaging with (e.g., during an insertion procedure or during a removal procedure) a connector 4 or a dust cap 8. As shown in FIGS. 13-16, a plurality of connectors 4 are inserted within ports 110 of a multi-port housing 100. In FIGS. 13 and 14, the tool 1 is in the second orientation (see, e.g., FIGS. 5, 6, 9, and 10) and engaging with one of the connectors 4. In FIGS. 15 and 16, the tool 1 is in the first orientation (see, e.g., FIGS. 3, 4, 7, and 8) and engaging with one of the connectors 4.

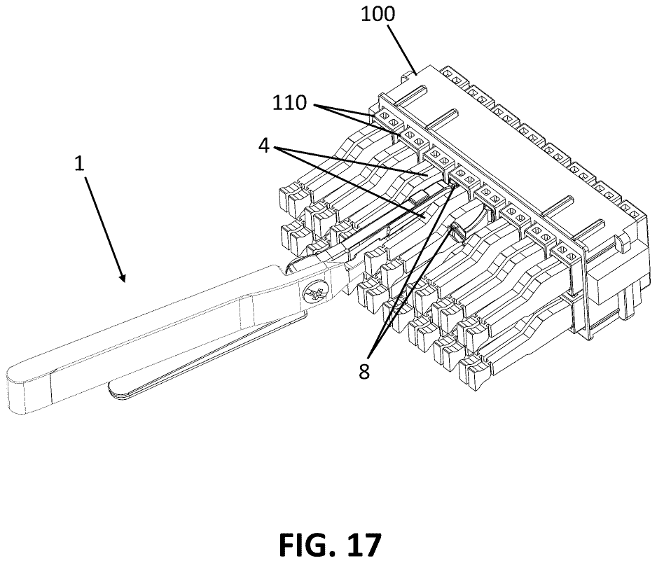

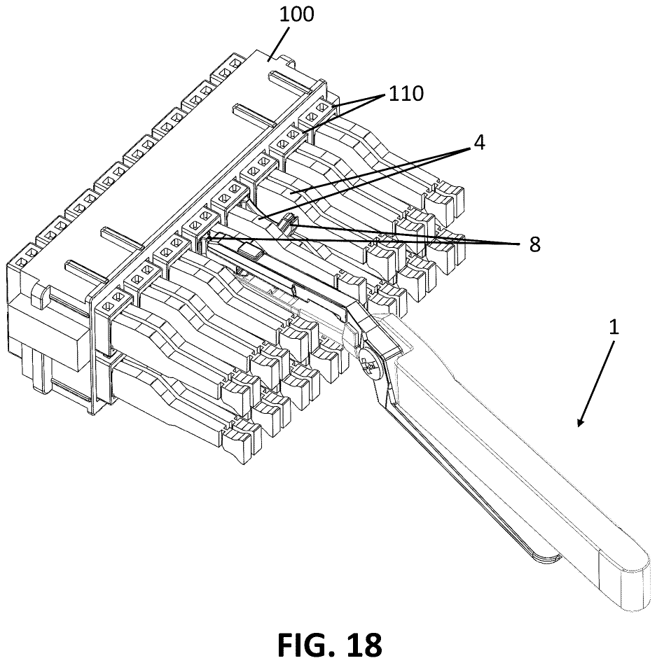

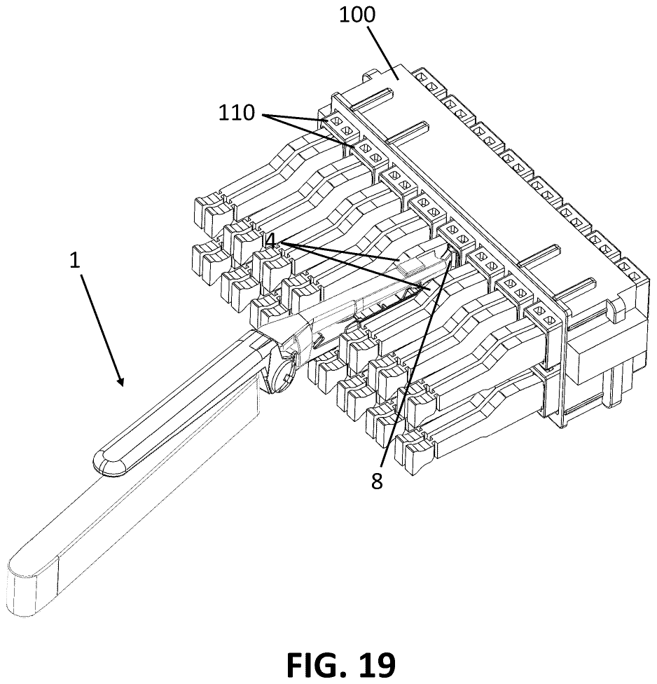

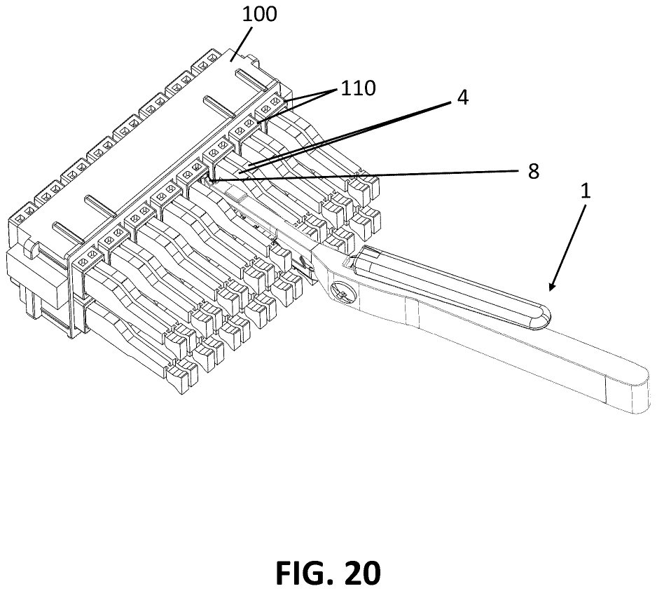

As shown in FIGS. 13-16, a plurality of connectors 4 and a plurality of dust caps 8 are inserted within respective ports 110 of a multi-port housing 100. In FIGS. 17 and 18, the tool 1 is in the second orientation (see, e.g., FIGS. 5, 6, 9, and 10) and engaging with one of the dust caps 8. In FIGS. 19 and 20, the tool 1 is in the first orientation (see, e.g., FIGS. 3, 4, 7, and 8) and engaging with one of the dust caps 8.

As shown in each of FIGS. 13-20, the grip portions 35, 75 are inclined at a non-zero angle relative to a direction of insertion/removal of the connector 4 and/or the dust cap 8. The angle of inclination of the grip portions 35, 75 is reversed between the first and second orientations of the tool 1. This angle can advantageously allow for a user to better visualize and ensure proper engagement with a designated connector 4 or dust cap 8.

The tool 1 disclosed herein significantly advances the state of the art by providing a robust, versatile, and user-focused solution for managing optical connectors and dust caps in environments where precision and reliability are critical. The tool 1 not only enhances operational efficiency but also substantially reduces the potential for network disruptions and, as such, the tool 1 will be an essential asset in modern data centers.

While the present disclosure refers to certain embodiments, numerous modifications, alterations, and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof. The discussion of any embodiment is meant only to be explanatory and is not intended to suggest that the scope of the disclosure, including the claims, is limited to these embodiments. In other words, while illustrative embodiments of the disclosure have been described in detail herein, it is to be understood that the inventive concepts may be otherwise variously embodied and employed, and that the appended claims are intended to be construed to include such variations, except as limited by the prior art.

The foregoing discussion has been presented for purposes of illustration and description and is not intended to limit the disclosure to the form or forms disclosed herein. For example, various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

The phrases “at least one”, “one or more”, and “and/or”, as used herein, are open-ended expressions that are both conjunctive and disjunctive in operation. The terms “a” (or “an”), “one or more” and “at least one” can be used interchangeably herein. All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., engaged, attached, coupled, connected, and joined) are to be construed broadly and may include intermediate members between a collection of elements and relative to movement between elements unless otherwise indicated. As such, connection references do not necessarily infer that two elements are directly connected and in fixed relation to each other. All rotational references describe relative movement between the various elements. Identification references (e.g., primary, secondary, first, second, third, fourth, etc.) are not intended to connote importance or priority but are used to distinguish one feature from another. The drawings are for purposes of illustration only and the dimensions, positions, order and relative to sizes reflected in the drawings attached hereto may vary.

1. A tool configured for installing within a port and removing from a port both a fiber optic connector and a dust cap for blocking the port, the tool comprising:
a first arm; and
a second arm pivotably attached to the first arm at a pivot point;
the first arm comprising, on a first side of the pivot point, a grasping portion;
the second arm comprising, on the first side of the pivot point, a grasping portion;
wherein the grasping portions of the first and second arms are configured to separately grasp and manipulate both the fiber optic connector and the dust connector;
the first arm comprising, on a second side of the pivot point, a grip portion;
the second arm comprising, on the second side of the pivot point, a grip portion; and
wherein the grip portions of the first and second arms are pivotable relative to each other, such that:
a pivoting movement of the grip portions of the first and second arms towards each other simultaneously causes a corresponding pivoting movement of the grasping portions of the first and second arms towards each other; and
a pivoting movement of the grip portions of the first and second arms away from each other simultaneously causes a corresponding pivoting movement of the grasping portions of the first and second arms away from each other.

2. The tool of claim 1, wherein the grasping portions of the first and second arms are positioned relative to each other such that a longitudinal axis of the grasping portion of the first arm is coplanar with a longitudinal axis of the grasping portion of the second arm.

3. The tool of claim 2, wherein the grip portions of the first and second arms are positioned relative to each other such that a longitudinal axis of the grip portion of the first arm is coplanar with a longitudinal axis of the grip portion of the second arm.

4. The tool of claim 3, wherein the grip portions are inclined at an angle relative to the grasping portions, such that the longitudinal axes of the grip portions are not coplanar with the longitudinal axis of the grasping portions.

5. The tool of claim 1, wherein the grasping portions each comprise a grasping profile configured to individually engage with both the fiber optic connector and the dust cap.

6. The tool of claim 5, wherein the grasping profile of each of the first and second arms comprises a recess into which a portion of the dust cap is insertable during installation and removal of the dust cap from the port.

7. The tool of claim 6, wherein the grasping portions are asymmetrically formed with respect to each other, such that a distance from a distal end of the first arm of the recess in the first arm is different from a distance from a distal end of the second arm of the recess in the second arm.

8. The tool of claim 7, wherein the recess of the first arm and the recess of the second arm are each formed such that no portion of the fiber optic connector is inserted therein during engagement of the tool with the fiber optic connector.

9. The tool of claim 1, comprising a central limiter that limits a magnitude of a pivoting movement of the first and second arms towards each other to avoid exerting excessive pressure or force on the fiber optic connector and the dust cap to avoid damage thereto.

10. The tool of claim 1, wherein the tool is reversible, such that the grasping portions of the first and second arms are both configured to grasp either of two opposing sides of the fiber optic connector and the dust cap.

11. A method of using a tool for installing within a port and removing from a port both a fiber optic connector and a dust cap for blocking the port, the method comprising:
providing the tool, the tool comprising:
a first arm; and
a second arm pivotably attached to the first arm at a pivot point;
the first arm comprising, on a first side of the pivot point, a grasping portion;
the second arm comprising, on the first side of the pivot point, a grasping portion;
the first arm comprising, on a second side of the pivot point, a grip portion; and
the second arm comprising, on the second side of the pivot point, a grip portion;
pivoting the grip portions of the first and second arms are relative to each other, such that:
a pivoting movement of the grip portions of the first and second arms towards each other simultaneously causes a corresponding pivoting movement of the grasping portions of the first and second arms towards each other; and
a pivoting movement of the grip portions of the first and second arms away from each other simultaneously causes a corresponding pivoting movement of the grasping portions of the first and second arms away from each other; and
when the grasping portions of the first and second arms are pivoted towards each other:
grasping and manipulating the fiber optic connector with the grasping portions of the first and second arms to insert or remove the fiber optic connector from the port; or
grasping and manipulating the dust cap with the grasping portions of the first and second arms to insert or remove the dust cap from the port.

12. The method of claim 11, wherein the grasping portions of the first and second arms are positioned relative to each other such that a longitudinal axis of the grasping portion of the first arm is coplanar with a longitudinal axis of the grasping portion of the second arm.

13. The method of claim 12, wherein the grip portions of the first and second arms are positioned relative to each other such that a longitudinal axis of the grip portion of the first arm is coplanar with a longitudinal axis of the grip portion of the second arm.

14. The method of claim 13, wherein the grip portions are inclined at an angle relative to the grasping portions, such that the longitudinal axes of the grip portions are not coplanar with the longitudinal axis of the grasping portions.

15. The method of claim 11, wherein the grasping portions each comprise a grasping profile that individually engages with both the fiber optic connector and the dust cap.

16. The method of claim 15, wherein the grasping profile of each of the first and second arms comprises a recess into which a portion of the dust cap is insertable during installation and removal of the dust cap from the port.

17. The method of claim 16, wherein the grasping portions are asymmetrically formed with respect to each other, such that a distance from a distal end of the first arm of the recess in the first arm is different from a distance from a distal end of the second arm of the recess in the second arm.

18. The method of claim 17, wherein the recess of the first arm and the recess of the second arm are each formed such that no portion of the fiber optic connector is inserted therein during engagement of the tool with the fiber optic connector.

19. The method of claim 11, wherein the tool comprises a central limiter that limits a magnitude of a pivoting movement of the first and second arms towards each other to avoid exerting excessive pressure or force on the fiber optic connector and the dust cap to avoid damage thereto.

20. The method of claim 11, wherein the tool is reversible, such that the grasping portions of the first and second arms are both configured to grasp either of two opposing sides of the fiber optic connector and the dust cap.
